(19) United States
(12) Patent Application Publication
(10) Pub. No.: US 2010/0136289 A1
(43) Pub. Date: Jun. 3, 2010

(54) ARTICLES COMPRISING WETTABLE STRUCTURED SURFACES

(76) Inventors: Charles W. Extrand, Minneapolis, MN (US); Sung In Moon, Chaska, MN (US)

Correspondence Address: Entegris, Inc., 129 CONCORD ROAD, BILLERICA, MA, 01821-4600, US

(21) Appl. No.: 12/600,670

(22) PCT Filed: May 19, 2008
(86) PCT No.: PCT/US08/06426

§ 371 Date: Nov. 18, 2009

Related U.S. Application Data
(60) Provisional application No. 60/939,709, filed on May 23, 2007.

(51) Int. Cl. B32B 3/10

(52) U.S. Cl. 428/141

(57) ABSTRACT

Embodiments of the invention include or comprise super wetting structured surfaces having one or more asperities, sometimes referred to as hemi-wicking. Structured substrates with regular arrays of asperities such as square pillars or frustra were machined from graphite blocks and then treated to render them lyophilic. Liquids spread over these surfaces to produce non-circular wetting areas. As the channels formed between the asperities were made shallower or narrower, liquids wicked more and spread over a larger area. The inherent wettability of the substrate was independent or nearly independent of the substrate. A combination of the appropriate surface structure and moderate inherent wettability can effectively flatten liquids, spreading them over very large areas.

This application claims the benefit of U.S. Provisional Patent Application No. 60/939,709, filed May 23, 2007, the contents of which are incorporated herein by reference in their entirety.

### BACKGROUND

A broad range of practical applications could benefit from lyophilic surfaces that cause liquids to spread completely. Such applications can include drying, bubble reduction in fluid handling systems, or the reduction of channel blockage in a device or an apparatus having fluid-liquid multiphase flow like fuel cells. While there are methods to render smooth lyophobic surfaces wettable, in practice it is difficult to maintain the lyophilicity of these surfaces if they are exposed to the ambient environment. These high-energy surfaces can quickly attract hydrocarbons and other low energy contaminants and consequently, their lyophilicity wanes.

Wetting phenomenon that combines lyophilicity with surface topography can be described by super wetting, super spreading, structure-assisted wetting, and hemi-wicking. If the same types of surfaces are rendered lyophobic, they may exhibit super lyophobic or super repellent behavior.

Wetting is determined by two competing forces. When a liquid drop is deposited on a solid surface, molecular interactions at the contact line drag the drop downward. From the perspective of the air-liquid interface, the drop is coerced into spreading. Prior to being placed on a surface, the drop has minimized its surface energy by minimizing its area. On a surface, when these diametrically opposed forces reach equilibrium, the drop stops spreading. On a smooth, flat surface, the extent of spreading of a liquid drop is usually quantified by an advancing contact angle, θₐ, depicted in FIG. 2. If θₐ is substantially greater than zero, for example 5-10 degrees, then the liquid is referred to as partially wetting. On the other hand for a smooth flat surface, a zero or near-zero, for example 0-5 degrees, value for θₐ is considered to characterize complete wetting.

### SUMMARY

Embodiments of the invention include or comprise a substrate having one or more treated surfaces with asperities, said asperities form intersecting capillary channels between the asperities, such that the treated surface with asperities can have an advancing contact angle as measured by a sessile drop of water that is at least 30 degrees, in some embodiments an advancing contact angle of at least 40 degrees less than an untreated surface of the substrate without asperities. Treated surfaces with larger advancing contact angles are more wettable. The treated surface with asperities can be characterized in that an area wet by a liquid spreading on the treated surface with asperities is proportional to the volume of a drop of the liquid disposed on the treated surface with asperities and where the strength of interaction of the liquid at the contact line with the treated surface with asperities is greater than the restoring forces associated with the air-liquid interfacial tension. A liquid on the treated surface with asperities is completely drawn into the intersecting capillary channels and the liquid establishes an advancing contact angle on the side of the asperities and forms menisci between said asperities.

In some embodiments of the invention, the asperities have a rise angle of about 90 degrees from the base of the capillary channels formed between said asperities, the asperities have one or more unit cells having a dimension y less than 1500 microns and maximum surface feature dimension x less than 1000 microns and height dimension z of less than 1000 microns.

Another embodiment of the invention is an article that includes or comprises a substrate having one or more treated surfaces with asperities, the asperities form intersecting capillary channels between the asperities, and the treated surface with asperities has an advancing contact angle as measured by a sessile drop of water that is at least 30 degrees less than an untreated surface of said substrate without asperities, and in some cases an advancing contact angle that is at least 40 degrees less than the untreated surface without asperities. The treated surface with asperities may be characterized in that an area wet by a liquid spreading on said treated surface with asperities is proportional to the volume of a drop of the liquid disposed on said treated surface with asperities and whereby the liquid on the structured surface drawn into the capillary channels does not establish an advancing contact angle on the side of the asperities and where the liquid does not forms menisci between said asperities. In some embodiments the asperities have a rise angle of less than 90 degrees and the capillary channels formed between the asperities have one or more unit cells having a dimension y less than 1200 microns and maximum surface feature dimension x less than 800 microns and height dimension z of less than 500 microns.

Another embodiment of the invention is a substrate having one or more treated surfaces with asperities, the asperities form intersecting capillary channels between the asperities. The treated surface with asperities can have an advancing contact angle as measured by a sessile drop of water that is at least 30 degrees less than an untreated surface of said substrate without asperities, in some embodiments an advancing contact angle of at least 40 degrees less than an untreated surface of the substrate without asperities. The treated surface with asperities can be characterized in that an area wet by a liquid spreading on the treated surface with asperities is proportional to the volume of a drop of the liquid disposed on the treated surface with asperities and where the contact line liquid force ratio fₗᵢₙₑ/f_{liquid} is equal to or greater than 1.4 where fₗᵢₙₑ is the force at the contact line and f_{liquid} is the interfacial force that resists spreading of the liquid according to the equation:

fₗᵢₙₑ/f_{liquid}=cos θₐ[1+2(z/y)(cscω−cot ω)]

where a dimension z is channel height, a dimension y is a measure of the unit cell, ω is the average rise angle and is about 90 degrees, and θₐ is the advancing contact angle of water; and wherein the treated surface with asperities is a fully compliant wetting hemi-wicking surface for water. In some embodiments the capillary channels formed between the asperities have one or more unit cells having the dimension y less than 1200 microns and maximum surface feature dimension x less than 800 microns and height dimension z of less than 500 microns. In some embodiments the asperities can form a square array.

Advantageously surfaces and articles in embodiments of the invention that include them can have enhance hydrophilicity and lyophilicity. Improved wetting can find use in a broad range of practical applications because such lyophilic surfaces can cause liquids to spread completely. Such applications can include drying, bubble reduction in fluid handling systems or photoresist packaging, or the reduction of channel blockage in a device or an apparatus utilizing open gas flow through small channels with fluid-liquid multiphase flow like fuel cells. Such surfaces can also reduce flush times for liquid handling components such as filters and housings, and reduce drying time for wafers carriers, disk shippers, head trays and the like which may be cleaned with aqueous solutions. The surfaces in embodiments of the invention can also lower chemical usage and improve drying times.

### BRIEF DESCRIPTION OF THE DRAWINGS

FIG. 1 A four microliter water drop that has spread on a smooth and structured graphite surfaces. Both surfaces have been treated such that their advancing contact angle is θₐ=40°. The structured surface consists of a regular array of square pillars (asperities) with width of x=390 μm, unit cell width of y=770 μm and height of z=420 μm. (a) Plan view of the wetted area of the smooth surface. (b) Side view of the wetted smooth surface. (c) Plan view of the wetted structured surface. (d) Side view of the wetted treated surface with asperities. The image inserted in (d) shows the side view of the treated surface with asperities before deposition of the liquid.

FIG. 2 A small, sessile, liquid drop that has spread on a smooth, solid surface. (a) Side view showing an advancing contact angle, θₐ. (b) Plan view showing a circular contact area, Aₛ.

FIG. 3 A schematic depiction of a surface that consists of a regular array of pyramidal frustra as asperities. (a) Plan view. (b) Side view. (c) Enlarged side view of a wetted unit cell.

FIG. 4 Plan view of the machining pattern that produces, a smooth section, two sections with parallel grooves, and a section with a regular array of features or asperities.

FIG. 5 The number of wetted cells, n, and the wetted area, A, for water on structured hemi-wicking surfaces, where the geometry was constant and lyophilicity was varied. The surfaces were covered with square pillar asperities (ω=90°) where x≈380 μm, y≈780 μm and z≈420 μm. Points are experimental data; solid lines from eqs (20) and (21).

FIG. 6 The number of wetted cells, n, and the wetted area, A, for various liquids on structured hemi-wicking surfaces. The structured surfaces were covered with an array of square pillar asperities (ω=90°) where x≈380 μm, y≈780 μm and z≈420 μm. The liquids were water with θₐ=40°, formamide (FA) θₐ=26° and ethylene glycol (EG) θₐ=17°. Points are experimental data; solid lines from eqs (20) and (21).

FIG. 7 The number of wetted cells, n, and the wetted area, A, for water on a series of structured hemi-wicking surfaces, where channel width, w (=y−x), between square pillar asperities (ω=90°) was held constant at 400 μm and pillar width to cell spacing ratios, x/y, were varied. z≈420 μm, and θₐ≈40°. Points are experimental data; solid lines are from eqs (20) and (21).

FIG. 8 The number of wetted cells, n, and the wetted area, A, for water on a series of structured hemi-wicking surfaces covered with square pillar asperities (ω=90°), where pillar width to cell spacing ratios were held constant at x/y=0.5 and unit cell widths, y, were varied. z≈420 μm and θₐ=40°. Points are experimental data; solid lines are from eqs (20) and (21).

FIG. 9 The number of wetted cells, n, and the wetted area, A, for water on structured hemi-wicking surfaces with various pillar heights or channel depths, z. The surface features were square pillar asperities (ω=90°) with x≈380 μm, y≈780 μm, and θₐ≈40°. The points are experimental data and the solid lines were calculated with eqs (20) and (21).

FIG. 10 The number of wetted cells, n, and the wetted area, A, for water on structured hemi-wicking surfaces covered with regular arrays of frustra (ω<90°) or square pillar asperities (ω=90°), where x≈500 μm, y≈1000 μm, z≈400 μm and θₐ=40°. Points are experimental data; solid lines from eqs (11), (12), (20) and (21).

FIG. 11 Calculated values of n_{f}/V and A_{f}/V versus y for water on hemi-wicking surfaces consisting of regular arrays of square pillar asperities, where θₐ=40°, w=z=y and x/y=0.50, 0.75 or 0.90.

FIG. 12 Illustrates drops on flat graphite surface treated (top) and the corresponding volume of liquid on treated substrates with pillar asperities below (lower). The results illustrate the increase in coverage with increasing drop volume and the fully compliant nature of the wetting on the structured surface.

### DESCRIPTION

While various compositions and methods are described herein, it is to be understood that this invention is not limited to the particular molecules, compositions, methodologies or protocols described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to an “asperity” is a reference to one or more asperities and equivalents thereof known to those skilled in the art, and so forth. Unless defined otherwise, all technical and scientific terms used herein have the same meanings as commonly understood by one of ordinary skill in the art. Methods and materials similar or equivalent to those described herein can be used in the practice or testing of embodiments of the present invention. All publications mentioned herein are incorporated by reference. Nothing herein is to be construed as an admission that the invention is not entitled to antedate such disclosure by virtue of prior invention. “Optional” or “optionally” means that the subsequently described event or circumstance may or may not occur, and that the description includes instances where the event occurs and instances where it does not. All numeric values are herein can be modified by the term “about,” whether or not explicitly indicated. The term “about” generally refers to a range of numbers that one of skill in the art would consider equivalent to the recited value (i.e., having the same function or result). In some embodiments the term “about” refers to ±10% of the stated value, in other embodiments the term “about” refers to ±2% of the stated value. While compositions and methods are described in terms of “comprising” various components or steps (interpreted as meaning “including, but not limited to”), the compositions and methods can also “consist essentially of” or “consist of” the various components and steps, such terminology should be interpreted as defining essentially closed-member groups.

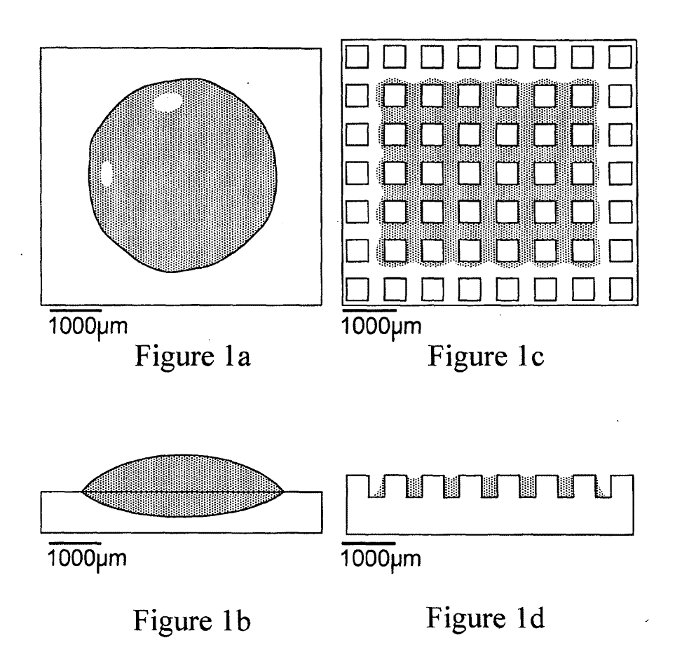

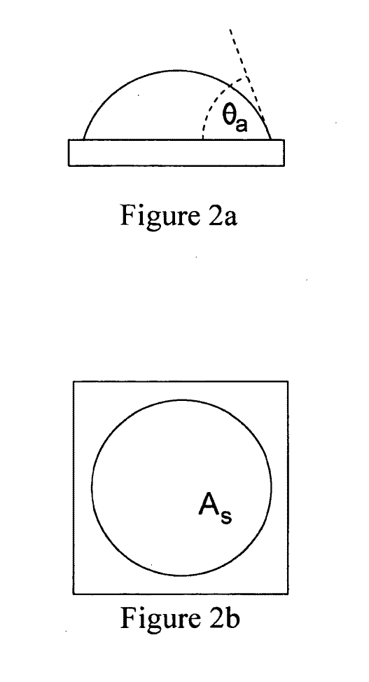

Embodiments of the present invention comprise or include surfaces with asperities that form two-dimensional arrays of intersecting capillary channels in these surfaces which can enhance the spreading of a liquid on these surfaces. In some embodiments the surfaces are lyophilic or treated to become more lyophilic than the untreated surface. These hemi-wicking surfaces can flatten drops such that their height is effectively zero. For surfaces in embodiments of the invention where a drop of liquid is leveled by such a hemi-wicking surface, the wetting behavior can vary due to the geometry of the surface, surface tension of the liquid and strength of the molecular interactions at the contact line (as gauged by contact angle). Embodiments of the invention comprise or include surfaces with asperities that result in hemi-wicking that can be fully compliant or partially compliant. In some embodiments surfaces have a structure or asperities that provides fully compliant wetting of hemi-wicking surfaces; this fully compliant wetting occurs if the strength of the interactions at the contact line is greater than the restoring forces associated with the air-liquid interfacial tension. In these versions the liquid is completely drawn into the interstitial spaces of the asperities and establishes an advancing contact angle on the sides of the asperities or lyophilic asperities. This leads to menisci between features as illustrated in FIG. 1(d). In some embodiments fully compliant wetting occurs when the advancing contact angle θₐ on the smooth surface of the material forming the substrate is characterized as being greater than zero. In other embodiments the surfaces have a structure that provides partially compliant wetting of hemi-wicking surfaces; partially compliant wetting would be any stage of spreading where the liquid does not establish its advancing contact angle in the volume between the asperities or the lyophilic features or asperities. For example, the liquid may have fully penetrated the interstitial spaces between features, but does not exhibit menisci. In some cases the liquid may have fully penetrated the interstitial spaces between features, but does not exhibit menisci, and the drop may have a thin liquid layer that blankets the features.

One embodiment of the present invention is an article that comprises or includes a substrate having one or more treated surfaces where the surfaces have one or more asperities. For example as shown in FIG. 1, the asperities form intersecting capillary channels between the asperities. The treated surface with asperities has an advancing contact angle as measured by a sessile drop of water that is at least 30 degrees less than an untreated surface of the substrate without asperities. Treatment of the surface can be by plasma treatment, wet chemical treatment, vapor deposition coating, any combination of these, or other means. In some embodiments the treated surface with asperities can be characterized in that an area wet by a liquid spreading on the treated surface with asperities is proportional to Vⁿ where n is greater than 0.67. In other embodiments the treated surface with asperities can be characterized in that an area wet by a liquid spreading on the treated surface with asperities is proportional to the volume of a drop of the liquid disposed on the treated surface with asperities and where the strength of interaction of the liquid at the contact line with the treated surface with asperities is greater than the restoring forces associated with the air-liquid interfacial tension. The drop of liquid on the treated surface with asperities is completely drawn into the intersecting capillary channels and the liquid establishes an advancing contact angle on the side of the asperities and forms menisci between said asperities; such as surface is a fully compliant hemi-wicking surface. The volume of the treated surface with asperities can be modified to incorporate different volumes of liquid by changing the number of asperities, their height, or the area of coverage.

In some embodiments of the fully compliant surface the asperities have a rise angle of about 90 degrees from the base of the capillary channels formed between said asperities to a region of the asperity and the asperities can form one or more unit cells having y less than 1200 microns and maximum surface feature dimension x less than 800 microns and asperity height z of less than 500 microns. In some embodiments the treated surface with asperities has an advancing contact angle as measured by a sessile drop of water that is at least 35 degrees less, in some embodiments at least 40 degrees less, and in still other embodiments at least between about 40 and 65 degrees less than an untreated surface of the substrate without asperities.

In some embodiments the surfaces can have asperities that have a rise angle of about 90 degrees from the base of the capillary channels formed between the asperities. The asperities have one or more unit cells having y less than 1500 microns and maximum surface feature dimension x less than 1000 microns and height z of less than 1000 microns. In some embodiments the treated surface with asperities has an advancing contact angle as measured by a sessile drop of water that is at least 35 degrees less, in some embodiments at least 40 degrees less, and in still other embodiments at least between about 40 and 65 degrees less than an untreated surface of the substrate without asperities.

One embodiment of the invention is a substrate having one or more treated surfaces with asperities, the asperities form intersecting capillary channels between the asperities. The treated surface with asperities has an advancing contact angle as measured by a sessile drop of water that is at least 30 degrees less than an untreated surface of the substrate without asperities. In some embodiments the treated surface with asperities can be characterized in that an area wet by a liquid spreading on the treated surface with asperities is proportional to Vⁿ where n is greater than 0.67. In other embodiments the treated surface with asperities can be characterized in that an area wet by a liquid spreading on the treated surface with asperities is proportional to the volume of a drop of the liquid disposed on the treated surface with asperities. The drop of liquid on the structured surface is drawn into the capillary channels but does not establish an advancing contact angle on the side of the asperities and the liquid does not forms menisci between said asperities; such a treated surface with asperities is a partially compliant hemiwicking surface. In some embodiments of the partially compliant surface the asperities have a rise angle of less than 90 degrees and the capillary channels formed between the asperities and the asperities can form one or more unit cells having y less than 1200 microns and maximum surface feature dimension x that can be less than 800 microns and height z of less than 500 microns. In some embodiments the partially compliant surface with asperities can have an advancing contact angle as measured by a sessile drop of water that is at least 35 degrees less, in some embodiments at least 40 degrees less, and in still other embodiments at least between about 40 and 65 degrees less than an untreated surface of the substrate without asperities. The volume of the treated surface with asperities can be modified to incorporate different volumes of liquid by changing the number of asperities, their height, or the area of coverage.

Embodiments of the invention can comprise or include a substrate having one or more treated surfaces with asperities, the asperities form intersecting capillary channels between the asperities. The treated surface with asperities has an advancing contact angle as measured by a sessile drop of water that is at least 30 degrees less than an untreated surface of the substrate without asperities. In some embodiments the treated surface with asperities can be characterized in that an area wet by a liquid spreading on the treated surface with asperities is proportional to Vⁿ where n is greater than 0.67. In other embodiments the treated surface with asperities can be characterized in that an area wet by a liquid spreading on the treated surface with asperities is proportional to the volume of a drop of the liquid disposed on the treated surface with asperities and where the contact line liquid force ratio fₗᵢₙₑ/f_{liquid} is equal to or greater than 1.4. In the contact line liquid force ratio fₗᵢₙₑ is the force at the contact line and f_{liquid} is the interfacial force that resists spreading of the liquid according to the equation:

fₗᵢₙₑ/f_{liquid}=cos θₐ[1+2(z/y)(cscω−cot ω)]

where for one or more unit cells of the asperities, z is channel height, y is the unit cell, ω is the average rise angle which is about 90 degrees, and θₐ is the advancing contact angle of water on a smooth treated surface. The treated surface with asperities with the contact line liquid force ratio equal to or greater than 1.4 is a fully compliant wetting hemi-wicking surface for water. In some embodiments the asperities can have one or more unit cells having y less than 1200 microns and maximum surface feature dimension x less than 800 microns and height z of less than 500 microns. In some embodiments the treated surface with asperities has an advancing contact angle as measured by a sessile drop of water that is at least 35 degrees less, in some embodiments at least 40 degrees less, and in still other embodiments at least between about 40 and 65 degrees less than an untreated surface of the substrate without asperities.

In various embodiments of the invention the treated surface having one or more asperities that form interconnected channels is wet by a liquid that penetrates the channels formed by the asperities. The liquid and channels in these embodiments can be described as satisfying the relationship θₐ+ω<180° where θₐ is the advancing contact angle and ω is the rise angle or an average rise angle of the asperities. Once liquid is in the channels, and where the channel walls are parallel and θₐ<90°, then the liquid will wick outward to occupy channels formed between other asperities. For some structured surfaces with features or asperities that have vertical walls (ω=90°) and θₐ<90°, liquids can penetrate the channels and hemi-wick. In other embodiments surfaces may not be perfectly smooth or homogeneous and the liquid wetting and penetrating the channels can be described by θₐ+ω<150°.

In some embodiments of the invention the structured surface and liquid can result in a void volume due to the meniscus that can represent 15% to 30% of available volume in each unit cell. In other embodiments the structured surface and liquid can result in a void volume due to the meniscus that can provide a void volume ranging from 10% to 40%.

Structure or texture as provided in embodiments of the present invention can greatly enhance spreading of liquids, even if the surface is only moderately lyophilic. For example in some embodiments the smooth surface has or can be treated to have θₐ>10 degrees, in other embodiments θₐ>25 degrees, and in still other embodiments θₐ>40 degrees as measured with water. In other embodiments the smooth surface can be treated to have an advancing contact angle θₐ that is at least 30 degrees less than the untreated surface as measured with a liquid such as water; in still other embodiments the smooth surface can be treated to have an advancing contact angle θₐ that is at least 40 degrees less than the untreated surface as measured with a liquid such as water; in yet still other embodiments the smooth surface can be treated to have an advancing contact angle θₐ that is at least between 40-65 degrees less than the untreated surface as measured with a liquid such as water. Examples of such surfaces as illustrated in Table 2 where graphite is the untreated surface. FIG. 1 illustrates examples of water that has spread on a smooth and structured lyophilic graphite surface. FIG. 1(c-d) is an illustration of a liquid such as water on a treated surface with asperities that exhibits fully compliant wetting in an embodiment of the present invention. FIGS. 1(a) and (b) show plan and side views of the smooth graphite surface. In this case, the spreading of a water drop yields a circular contact area. Viewed from the side, the drop has a finite cross-sectional area that resembles a segment of a circle. The wetting behavior on the corresponding structured treated surface with asperities is quite different as shown in FIGS. 1(c) and (d). Viewed from above, the liquid contact patch corresponds to the asperities on the surface, in other words the contact patch approximately square-shaped and corresponds to the array of asperities. Viewed from the side, the liquid is drawn into the capillary structure and resides at or below the upper plane of the surface features. Viewed from the side, the liquid in the capillary structure exhibits menisci between the surface features or channels formed by the asperities. The asperities can be but are not limited to structures like fustra or pillars (square pillars shown) that form intersecting capillary spaces or channels between them.

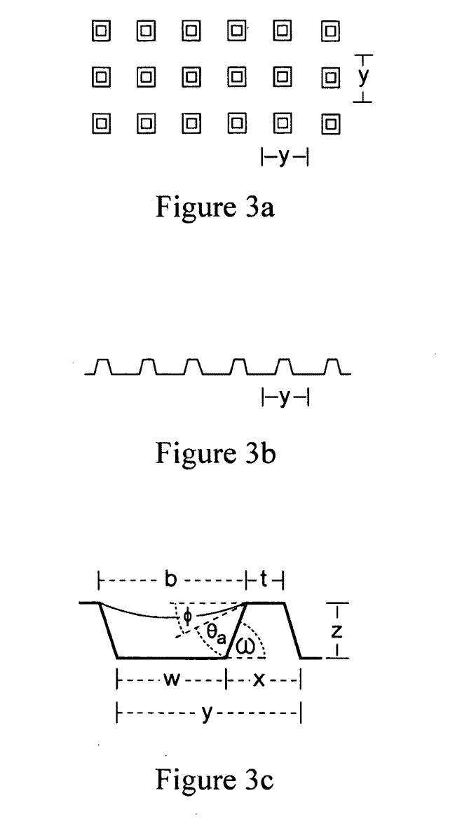

The asperities or surface features may be formed in or on the substrate material itself or in one or more layers of material disposed on the surface of the substrate. The asperities may be any regularly or irregularly shaped three dimensional solid or cavity and may be disposed in any regular geometric pattern. Non-limiting examples of asperities include the square shaped asperities in FIG. 1(c) and FIG. 1(d) and the fustra shaped asperities in FIG. 3(c), other asperity shapes may include cylinders, and combinations of these.

The asperities may be formed using machining, photolithography, or using methods such as but not limited to machining, nanomachining, microstamping, microcontact printing, self-assembling metal colloid monolayers, atomic force microscopy nanomachining, sol-gel molding, self-assembled monolayer directed patterning, chemical etching, sol-gel stamping, printing with colloidal inks, or by disposing a layer of carbon nanotubes on the substrate.

A wide assortment of methods could be used to create these surfaces including various molding processes. Examples of moldable materials that could be used to make textured surfaces in embodiments of the invention via injection molding include but are not limited to thermoplastics such as polyethylene (PE), polypropylene (PP), polycarbonate (PC), polyether ether ketone (PEEK), and perfluorinated thermoplastics like PFA and FEP. In addition to texture as described herein, materials that have low surface energy, such as PFA, FEP and PTFE, can use surface treatments to make them hydrophilic or lyophilic, see for example U.S. Pat. No. 6,354,443 incorporated herein by reference in its entirety. For injection molded parts, the reverse image of the desired texture could be burned into the mold.

In some embodiments the asperities or features need not lie on an intersecting grid. A properly designed array of parallel channels or rows would also work. Accordingly embodiments of the invention can be made by extrusion techniques. For example for extruded parts, features could be added to the die head to introduce parallel grooves into the plastic profile.

Although in FIG. 1 the asperity rise angle ω is 90 degrees, other asperity geometries and rise angles are possible as shown for example from various samples in Table 2 or for example in FIG. 3 where ω may be an acute angle.

It will also be appreciated that a wide variety of asperity shapes and arrangements are possible within the scope of the present invention. For example, asperities may be polyhedral, cylindrical, cylindroid, or any other suitable three dimensional shape. The asperities may also be randomly distributed so long as force ratio is maintained at or about 1.4 or greater for fully compliant surfaces. The contact line density and other relevant parameters of the asperities may be conceptualized as averages for the surface. The asperities may also be interconnected cavities formed in the substrate. In some embodiments the asperities do not contain structures that may be used or subsequently converted into use for mechanical operations, digital and or optical processing. In some embodiments the asperities are passive structures.

The asperities may be arranged in a rectangular array as shown in FIG. 1, in a polygonal array such as the hexagonal array, or a circular or ovoid arrangement, or combinations of these, or other arrangements. The asperities may also be randomly distributed so long as the contact line force ratio is maintained at 1.4 or more for fully compliant hemiwicking surfaces. In such a random arrangement of asperities, the intersecting capillary channels and other relevant parameters may be conceptualized as averages or may be characterized in regions for the surface.

Capillary structures in embodiments of the invention can include intersecting channels having a width of about 1-3 microns, or in some embodiments less than 1 micron, and a depth of about 1 micron or less. The channels can intersect in a patterned or random manner.

Materials for the surface can include polymers, or composites of polymers and filler such as ceramics, carbon comprising fibers or nanofibers and the like, carbon based materials such as graphite, and materials having a coating that can be lyophilic or made lyophilic upon further treatment.

In embodiments of the invention the smooth base material can be lyophilic or can optionally be made lyophilic by a surface treatment or coating. The lyophilicity being characterized by an advancing contact angle for a sessile drop of water on the smooth horizontal surface, the advancing contact angle in some embodiments being less than 80 degrees, in some embodiments less than 40 degrees, in other embodiments less than 30 degrees, in still other embodiments less than 20 degrees, and in yet still other embodiments less than 15 degrees. The lyophilicity can also be characterized relative to the untreated surface and in some embodiments the surface treatment such as by oxidation, coating, or combination of these may decrease the contact angle by 30 degrees or more relative to the untreated surface; in some embodiments the surface treatment may decrease the contact angle by 40 degrees or more relative to the untreated surface; in still other embodiments the surface treatment may decrease the contact angle by from 40 to 65 degrees or more relative to the untreated surface. The embodiments may include fully compliant or partially compliant surfaces.

The wetting behavior of fully compliant or partially compliant hemi-wicking surfaces in versions of the invention can be described quantitatively. Consider a surface covered with a regular array of lyophilic features. FIG. 3 shows an enlarged side and plan view of a structured surface comprised of pyramidal frustra with top width of t, base width of x, unit cell width of y, and height of z. In various embodiments of the invention the surface feature parameter values y, z, and ω, to can be an average value of any of these parameters, or an average value with some variation or distribution of these values within about ±10%. Although the surface is assumed horizontal as depicted, embodiments of the partially or fully compliant surfaces of the invention are not limited to horizontal surfaces. The rise angle of the surface features or an average is ω and the spacing between the tops or an average of the features is b. The distance between the features at their base, which is a gauge of channel width, is w. If the rise angle ω=90°, then the frustra become square pillars where t=x and b=w. Otherwise, for other embodiments where ω<90°, then the top width of the features can estimated from the feature dimensions and ω,

t=x−2z cot ω. (1)

The volume of liquid in each wetted unit cell, Vᵤ, can be estimated as

Vᵤ=Vₜ−V_{f}−V_{c}, (2)

where Vₜ is the total volume of each unit cell, V_{f} is the volume of the feature and V_{c} is the volume of air due to the meniscus. The total volume of each unit cell, Vₜ, is

Vₜ=y²z (3)

and the volume of the feature, V_{f}, is

V_{f}=(1/3)z[x²+(x−2z cot ω)²+x(x−2z cot ω)]. (4)

The enlarged side view of the wetted unit cell in FIG. 3 shows the meniscus that form due to interaction of a fully compliant liquid with the lyophilic structured surface. The liquid can wet the sides of the features with its advancing contact angle, θₐ, and the geometric relation between θₐ and the meniscus angle, φ, is

φ=ω−θₐ. (5)

In the non limiting embodiment shown, the cross-sectional area of the meniscus, A_{c}, has the shape of the segment of a circle

A_{c}=(1/4)b²(φ−cos φ sin φ)/sin²φ, (6)

where

b=y−x+2z cot ω. (7)

Thus, the volume of air in each unit cell due to the air-liquid interfacial curvature, V_{c}, can be approximated from x, y and A_{c} as

V_{c}=(y+x−z cot ω)A_{c}. (8)

By combining eqs (6)-(8), V_{c} becomes

V_{c}=(1/4)(y+x−z cot ω)(y−x+2z cot ω)²(φ−cos φ sin φ)/sin²φ. (9)

It is possible to count the number of wetted number cells for a surface with asperities or measure the wetted area. The number of fully-filled cells, n_{f}, can be calculated from the volume of liquid deposited on the surface, V, and the volume of a fully filled unit cell, Vᵤ,

n_{f}=V/Vᵤ. (10)

Combining eqs (2-4) and (9) and substituting into equation (10) results in an expression that allows for the estimation of the number of filled unit cells from the deposition volume, surface geometry and wettability of the surface,

n_{f}=V{y²z−(1/3)z[x²+(x−2z cot ω)²+x(x−2z cot ω)]−(1/4)(y+x−z cot ω)(y−x+2z cot ω)²(φ−cos φ sin φ)/sin²φ}⁻¹ (11)

For cells whose area is fully-filled or covered, the wetted area A_{f} can be estimated as

A_{f}=V{z−(1/3y²)z[x²+(x−2z cot ω)²+x(x−2z cot ω)]−(1/4y²)(y+x−z cot ω)(y−x+2z cot ω)²(φ−cos φ sin φ)/sin²φ}⁻¹ (12)

If the surface features are square pillars (ω=90°), then for example

n_{f}=(V/y²){z[1+(x/y)²]−(y/4)(1+x/y)(1−x/y)²(φ−cos φ sin φ)/sin²φ}⁻¹ (13)

and

A_{f}=V{z[1+(x/y)²]−(y/4)(1+x/y)(1−x/y)²(φ−cos φ sin φ)sin²φ}⁻¹ (14)

Similar expressions can be derived for n_{f} and A_{f} for other shaped surface features or asperities. Surfaces can be designed with n_{f} and A_{f} made large enough and the contact angle made low enough by optional surface treatment to provide stable lyophilic surfaces that result in partial or fully compliant wetting and hence accommodate an expected volume of liquid V; the surfaces can be made with a known or range of surface energies and hence meniscus angle, φ, to accommodate an expected volume of liquid. Where some cells are less than fully filled with the liquid, the values of n_{f} and A_{f} can be made larger to accommodate the expected increase in the number of cells n and area filled (A) by the liquid as described herein. A fully filled cell refers to a cell where the contact line for the liquid occurs at edges of the asperity between the top surface and side wall of the asperity.

Depending upon the advancing contact angle of the liquid and the geometry of the asperities and intersecting channels they form, surfaces with asperities (optionally treated) can be formed using Eqs (11)-(14) such that the number and area of unit cells needed to accommodate an expected volume of liquid can be formed. In some embodiments surfaces with asperities can be made to accommodate an expected volume of liquid where some of the unit cells of the surface are less than fully filled with liquid. For example, in some embodiments the number of wetted unit cells that accounts for edge effects, n_{c}, can be estimated by assuming that the wetted area consists of a square array of nₑ^{1/2}×nₑ^{1/2} features. The number of unit cells with the middle region, nₘ, of the wetted square area can be

nₘ=(nₑ^{1/2}−2)², (15)

the number along the sides of the perimeter is

nₛ=nₑ−(nₑ^{1/2}−2)²−4, (16)

and the number at of corners is

n_{c}=4. (17)

In a non-limiting example, one approximation for a surface with asperities, optionally treated to modify its surface energy, is to assume that the unit cells along the sides are three-fourths full (¾ Vᵤ) and those at the corners are half full (½ Vᵤ). Thus, accounting for edge effects, the volume of the liquid deposited on a structured surface is equivalent to the sum of the wetted unit cells in the middle, sides and corners,

V=nₘVᵤ+nₛ(¾Vᵤ)+n_{c}(½Vᵤ). (18)

Combining eqs (10) and (15-18) gives

n_{f}=nₑ−nₑ^{1/2}. (19)

Using the quadratic formula, nₑ can be solve for in terms of n_{f},

nₑ=n_{f}+(n_{f}+¼)^{1/2}+½. (20)

For a given surface structure, a wetting area that accounts for edge effects, Aₑ, can be estimated as

Aₑ=(nₑ/n_{f})A_{f} (21)

or as the product of nₑ and the planar area of each unit cell, Aᵤ,

Aₑ=nₑAᵤ=nₑy². (22)

In some embodiments the structured surfaces with asperities produce wetted areas that are roughly square-shaped, the perimeters of these wetted areas are approximately or about

pₑ=4nₑ^{1/2}y. (23)

In some embodiments of the invention the unit cells along the edge can contain even less liquid than described above. Various geometric parameters such as contact angle, drop volume and/or surface geometry, liquid-solid contact area, air-liquid interfacial area and perimeter of small drops on smooth surfaces, as well as the relative increase in air-liquid interfacial area between features due to meniscus curvature and the depth of meniscus penetration into unit cells can be used to derive similar equations to those given above and can be used to make surfaces with varying areas and asperities that accommodate varying amounts of liquid filling along their edges.

In some embodiments of the invention the amount of liquid, for example water, that will be present may be unknown and dependent upon operating or process conditions at the structured surface of the article. For example in a fuel cell the amount of water that condenses in the channels of the distribution plates may vary during operation of the fuel cell. The structured surface with asperities may be used to remove water condensation from the distribution plate channels by partial or fully compliant wetting of a structured plate surface thereby allowing fuel gases to enter the electrode. The liquid water in the capillaries of the fuel cell plate can then be removed from the plate by known methods. Embodiments of the invention may be used to increase the interfacial area of a liquid that completely wets or partially wets the structured surface and increase the rate of evaporation of the liquid from the surface. This may be useful for evaporative cooling apparatus and operations as well as reducing the amount of time and energy required to clean and dry articles that have been wet such as but not limited to tubing, filter housings, wafer carriers, FOUPs, SMIF pods, reticle pods, chip trays, head trays, and the like.

For example, in the non-limiting illustration above, wetted unit cells along the perimeter were only partially filled: those along the sides are three-fourths full and those at the corners are one-half full. Closely related equations can be derived for perimeter cells that contain less liquid than the previous case. For example, if it is assumed that the unit cells along the sides are one-half full and those at the corners are one fourth-full, then

nₑ=(n_{f}^{1/2}+1)². (26)

If the side and edge cells contain even less liquid such that the sides are one-fourth full and the corners are one-eighth full, then

nₑ=n_{f}+3[(9/4)+(n_{f}−2½)]^{1/2}+2. (27)

Generally as the fraction of the liquid in the perimeter unit cells decreases, a larger area is wetted to accommodate a given volume of liquid. By using equations (23) and (13) and nₑ derived as in (26), (27), or the like, the perimeter of wetting can be determined and the number of unit cells and area for a given expected volume of liquid can be determined and formed in a given surface. Surfaces having a greater number or lesser number of unit cells and area can be made accordingly.

The following equations can be used to estimate various geometric parameters from contact angle, drop volume and/or surface geometry. For a small liquid drop volume that retains spherical proportions as it spreads on a smooth surface, i.e., gravity does not distort it, liquid-solid interfacial area can be estimated as,

Aₛ=π^{1/3}(6V)^{2/3}{tan(θₐ/2)[3+tan²(θₐ/2)]}^{-2/3}, (28)

the gas-liquid interfacial area as,

S=2(9π)^{1/3}(V)^{2/3}[(1−cos θₐ)(2+cos θₐ)²]^{-1/3} (29)

and perimeter as

pₛ=2π^{2/3}(6 V)^{1/3}{tan(θₐ/2)[3+tan²(θₐ/2)]}^{-1/3}. (30)

The relative increase in air-liquid interfacial area between features due to meniscus curvature can be calculated as

Aₘ/Aₙₘ=(θₐ−ω)/sin(θₐ−ω). (31)

The depth, dₘ, of the meniscus penetration into a cell is

dₘ=[(y−x+2z cot ω)/2] tan[((ω−θₐ)/2]. (32)

Contact line-liquid force ratio. When a liquid drop is deposited on a solid surface, molecular interactions advance the contact line against the area-minimizing forces of the air-liquid interface. The relative strength of the molecular interactions at the contact line versus the restoring force of the air-liquid interface can be used to determine whether the spreading of a liquid on a hemi-wicking surface is fully or partially compliant.

Without wishing to be bound by theory, to make a first order estimate of the relative magnitude of these forces, any increase in the forces at the contact line, fₗᵢₙₑ, can be estimated to be proportional to the increase in the length of the contact line per unit cell, L, and the component of the liquid surface tension, γ, that parallels the surface geometry,

fₗᵢₙₑ=Lγ cos θₐ, (33)

where the increase in the of contact line per unit cell is

L=y+2z(cscω−cot ω). (34)

The interfacial forces that resist the spreading of the liquid can be approximated as

f_{liquid}=γy. (35)

By combining equations (34) and (35) and taking the ratio of the line and areas forces, the relative contribution to the topography driven spreading can be:

fₗᵢₙₑ/f_{liquid}=cos θ[1+2(z/y)(cscω−cot ω)]. (25)

For fully compliant wetting of structured surfaces that have a smooth surface contact angle greater than zero and an asperity rise angle of about 90 degrees or 90 degrees, the ratio fₗᵢₙₑ/f_{liquid} is greater than 1.4, in some cases greater than 1.6, and in still other embodiments or versions greater than 2. These surfaces can be made fully compliant hemi-wicking surfaces by choosing surface feature parameter values y, z, and ω, to yield these ratios and by optionally treating the surface of the substrate or asperities to modify the contact angle. In various embodiments of the invention the surface feature parameter values y, z, and ω, to can be an average value of any of these parameters, or an average value with some variation or distribution of these values, however the ratio fₗᵢₙₑ/f_{liquid} for these averages is greater than 1.4, in some cases greater than 1.6, and in still other embodiments or versions greater than 2.

### Example 1

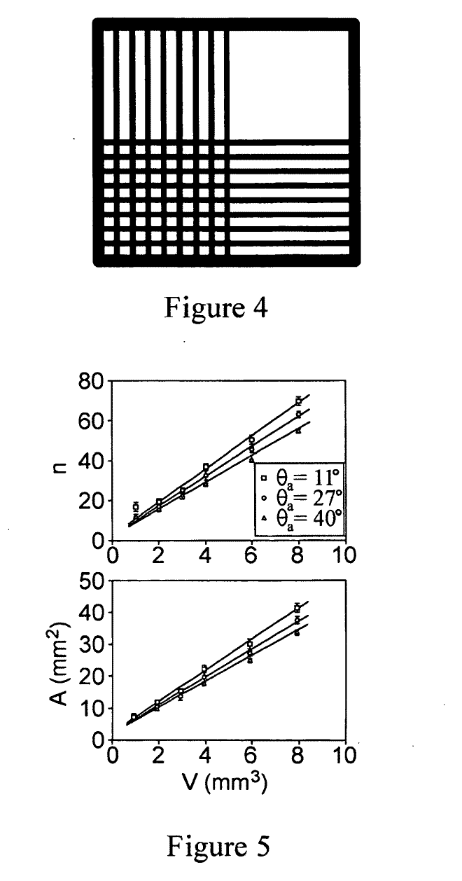

Structured substrates were machined from 5 cm×5 cm×1 cm graphite blocks (Poco Graphite, Inc., Grade: EDM-AF5) using carbide- or diamond-like-carbon-coated cutters. Parallel paths were cut in one direction, then the block was rotated, and parallel paths were again cut to create a grid array. In each cutting direction, the parallel paths were cut such that top surface of the block was divided into four quadrants as depicted in FIG. 4, one smooth quadrant (no lines, top right quadrant), two with parallel grooves (top left and bottom right quadrants), and one with a regular array of features (bottom left quadrant). Cutter depth and distance between paths were varied to produce structured surfaces with the desired feature size and spacing. In most cases, a square-ended cutter was used to create square pillars and square bottomed channels. Other cutter shapes were used to make features with other shapes, such as frustra.

The dimensions of the structured surfaces and their wetting behavior were observed with the aid of optical microscopy. Images were captured at 50× magnification using a Nikon Eclipse ME600L microscope with a DXM 1200 digital camera. Feature width and spacing was measured with Image-Pro Plus software. Feature height and wetting behavior were observed at lower magnifications (10× to 20×) using Nikon SMZ1500 microscope with a DXM1200 digital camera.

Before the wetting experiments, blocks were washed with isopropanol, then DI water, and allowed to air dry. After cleaning, the graphite was relatively lyophobic. The surface of graphite was rendered lyophilic by oxidation treatment (similar treatment were also used on surfaces in examples 2-7 as noted below). Immediately after oxidation surface treatment, the flat or featureless portions of the oxidized surfaces were nearly water wettable. Over the course of several days, the treated surfaces slowly recovered their hydrophobic nature. At intervals during this period, wetting measurements were performed on both the featureless and structured portions of the graphite blocks.

The wetting liquids used in various examples described herein were 18 MΩ de-ionized water, formamide (Alfa-æsar, ACS, 99.5+%) and ethylene glycol (Simga-Aldrich, anhydrous, 99.8%). Liquids drops were gently extruded from a one-milliliter, glass syringe (M-S, Tokyo, Japan). Syringe plunger displacement was converted to liquid volume, V. After gently depositing drops on the smooth quadrant of a substrate, advancing contact angles, θₐ, were measured with a Krüss drop shape analyzer (DSA10). For drops deposited on the structured areas, the number of unit cells wetted by the spreading liquid, n, was tallied. These measurements were usually done in triplicate; an average and standard deviation were computed. For a given surface structure, spreading areas, A, were estimated by multiplying the number of wetted unit cells, n, by the planar area of the unit cell, Aᵤ,

A=nAᵤ=ny². (24)

The uncertainty in “A” was estimated by standard error propagation methods using standard deviations from n and y measurements.

Fully compliant super wetting or fully compliant hemi-wicking can be achieved on one or more portions of a surface by covering these portions by an array of features or asperities that create a network of intersecting capillary channels; the array can be regular or random. FIG. 1(c-d) shows an example of an embodiment of a fully compliant surface that can flatten drops such that their height is effectively zero and where θₐ is not 0° or not less than about 5° for the structured surface with asperities on the substrate. For example, a smooth portion of this graphite test specimen was hydrophilically-treated so that θₐ was about 40°; its advancing contact angle was therefore reduced by about 40° assuming an advancing contact angle for untreated graphite of about 80°. Water spread on the smooth portion to produce a circular patch as shown in FIG. 1a. The area of the circular contact patch was 11 mm² and the air-liquid interfacial area was approximately 13 mm². The structured portion of the surface for this test specimen was covered with an array of square pillar asperities that created an interconnected network of lyophilic capillary channels that enhanced spreading of the liquid. Wetting on this structured surface with water was fully compliant as illustrated in FIG. 1c and FIG. 1d.

In contrast to the smooth surface in FIG. 1a, water spread on the treated surface with asperities in FIG. 1(d) to create a wetted area that was approximately square shaped, where 30 unit cells contained water. The unit cells around the perimeter were partially filled; the twelve unit cells in the inner region were fully filled. The wetted area of the structured surface was much larger, 18 mm², than the smooth surface. On the hemi-wicking surface, the height of the water drop and its cross-sectional area were essentially reduced to zero.

The areas listed here for the structured surfaces generally are planar approximations that were estimated from a tally of wetted unit cells. These areas do not account for the dry tops of the features that may protrude from the liquid film or for the curvature of the liquid between features. In the example given above, subtracting the area of the feature tops reduces the interfacial area from 18 mm² to 14 mm². Accounting for the meniscus curvature increases the estimate from 14 mm² to 16 mm².

Arbitrary liquid volumes typically did not produce perfectly symmetric wetting patterns. For the surface shown in FIG. 1, if a water drop with a volume of approximately 4.6 mm³ were deposited, the resulting wetted area would have been perfectly square consisting of a matrix of 36 wetted unit cells, with six wetted cells per side (n^{1/2} equals an integer). A slightly smaller or slightly larger volume would almost certainly have led to an “incomplete” row that was either partially filled or empty.

Table 1 lists the number of wetted unit cells and wetted areas for water drops with volumes, V, ranging from one to eight cubic millimeters. This prepared structured surface resembled the one shown in FIG. 1. It consisted of a regular array of square pillars (ω=90°) with width of x=380 μm and height of z=420 μm, unit cell width of y=780 μm, and advancing contact angle of θₐ=40°. The wetting of this surface was fully compliant. Values of V, n, and A were determined experimentally. n_{f} and A_{f} were calculated with eqs (13) and (14) using experimentally determined values of surface geometry and wettability, then in turn nₑ and Aₑ were computed with eqs (20) and (21). Values that account for edge effects, nₑ and Aₑ, agree with the measured values, n and A. These results show that for a given volume of liquid, a structured surface in embodiments of the invention can be made that results in fully compliant wetting.

The liquid volume displaced by the meniscus can be quantified from eqs (13) and (14). The first term in the denominator, z[1+(x/y)²], gives the total volume that would be occupied if the air-liquid interface were flat (a meniscus of zero curvature). The second term, (y/4)(1+x/y)(1−x/y)²(φ−cos φ sin φ)/sin²φ, estimates the excluded volume due to the curvature of the meniscus. In the fully wetted inner region, the total volume available in each unit cell was 0.194 mm³. The presence of the meniscus reduced that volume by 0.030 mm³ or approximately 15%. As y tends toward zero, the volume of air above the meniscus and between the feature top surface declines. For instance, if values of z and x/y were held constant (z=420 μm and x/y=0.5) while shrinking the lateral dimensions of this structured surface, then the contribution from the meniscus volume declines to 5% for y=250 μm. For y<1 μm, the contribution of the meniscus term would be insignificant.

Where structured surfaces have relatively large unit cell dimensions and relatively few unit cells edge effects can become important. The difference between calculated values of n_{f} and nₑ generally was large for small V, but diminished as the number of wetted unit cells increased. Note that for the largest liquid volume used, V=96 mm³, ignoring the edge effects still give a reasonable estimate of n and A. This is the expected outcome based on comparison of calculated n_{f} and nₑ values. For example, if n_{f}=30, then the difference between n_{f} and nₑ is 20%. If the number of wetted features is 300, then their difference falls to 6%. For 3000 wetted features, it is less than 2%.

### Example 2

FIG. 5 shows plots of the number of wetted cells, n, and the wetted area, A, versus volume for water on structured hemi-wicking surfaces, treated graphite with pillar asperities, where the geometry was constant and lyophilicity was varied. The lyophilicity was varied by changing the duration of the oxidation surface treatment. The surface, similar to that for Table 1, was covered with square pillars (ω=90°) where x≈380 μm, y≈780 μm and z≈420 μm. Points are experimental data (see Table 2, samples 1-3); solid lines are model calculations based on eqs (20) and (21). Both n and A are observed to increase linearly with V. The wetting was fully compliant and thus the proposed model fit the experimental data well. Even though the hydrophilicity of the surfaces varied; these structured surfaces were all fully compliant hemi-wicking.

It was observed that beyond the distinctive shape of the wetting patterns, the structured surfaces differed dramatically from the smooth surfaces in several other regards. For a surface having a given advancing contact angle, the area wetted by a liquid spreading on a smooth surface scales as V^{2/3}. Unexpectedly it was observed that the area (A) wetted by a liquid spreading on a structured hemi-wicking surface in embodiments of the invention for a given advancing contact angle (determined by treatment or coating) was approximately proportional to V. For smooth hydrophilic surfaces, area and perimeter can increase significantly with small decreases in θₐ. For example, if θₐ is reduced from 40° to 10°, then A increases by 166%. On the other hand, for the structured hemi-wicking surfaces shown in FIG. 5, a reduction in θₐ from 40° to 10° only increases A by 19%. Generally the surface with asperities, optionally surface treated, in versions of the invention can be characterized in that an area wet by a liquid spreading on the surface with asperities is proportional to Vⁿ where n is greater than 0.67 in some embodiments and n is about 1 in other embodiments.

In principle, if θₐ+ω<180°, then the wetting liquid should penetrate the channels formed by the asperities in versions of the invention. Once the liquid is in the channels, if the channel walls are parallel and θₐ<90°, then the liquid should wick outward. For the structured surfaces with features or asperities that had vertical walls (ω=90°) and θₐ<90°, liquids would have been expected to penetrate the channels and hemi-wick. It was observed that the graphite surfaces used here were not perfectly smooth nor were they homogeneous. It was observed that square pillars with θₐ>60° did not allow water to readily penetrate and spread. It can be that other materials and surface finishes would permit water to penetrate and spread or that the advancing contact angle could be modified by further surface treatment to achieve liquid penetration into the channels.

For the surfaces shown in FIG. 5, the void volume due to the meniscus represents 15% to 28% of available volume in each unit cell. For all the structured surfaces examined herein, see for example Table 2, the fraction of the void volume was bit broader, ranging from 11% to 38%.

### Example 3

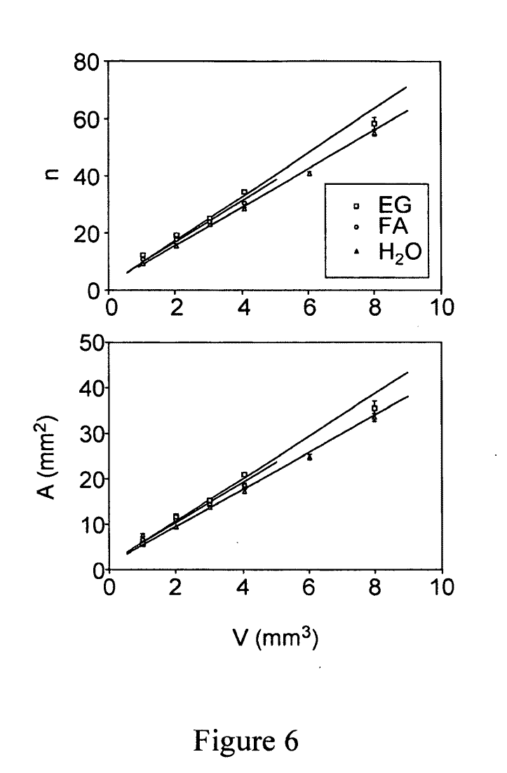

FIG. 6 shows the number of wetted cells, n, and the wetted area, A, plotted against volume, V, for various liquids on a structured hemi-wicking surfaces (treated graphite with pillar asperities). The liquids, see samples 4-6 Table 2, were ethylene glycol (EG) with θₐ=17°, formamide (FA) with θₐ=26° and water with θₐ=40°. The surfaces were covered with an array of square pillars (ω=90°), where x≈380 μm, y≈780 μm and z≈420 μm. Experimental data in FIG. 6 are shown as points. Water on this particular surface geometry had an advancing contact angle θₐ=40° and showed fully compliant hemi-wicking, see previous Example and FIG. 5. With other liquids providing lower θₐ values than water, the strength of the interactions at the contact line of both ethylene glycol(EG) and formamide(FA) were even greater than those of water. Similarly, lower γ values reduced the restoring forces acting at the air-liquid interface. As shown, EG and FA also were fully compliant (contact force ratio 1.4 or greater for asperity rise angle about 90 degrees). Eqs (20) and (21), shown as solid lines, again adequately described the hemi-wicking.

### Example 4

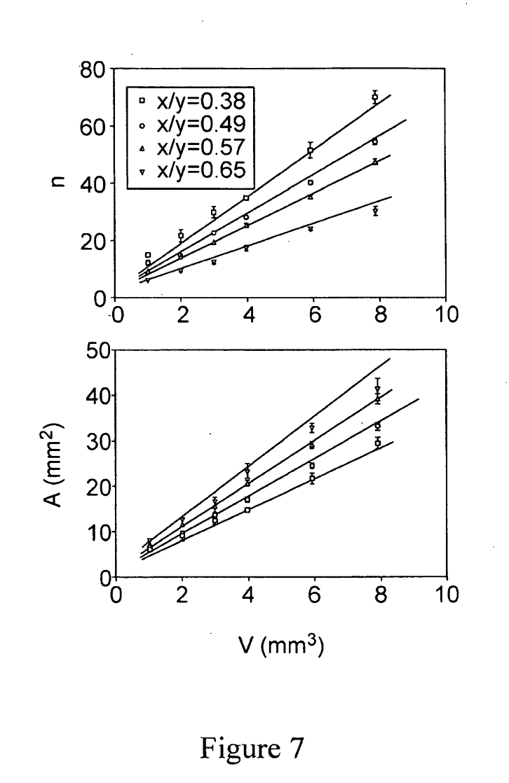

FIG. 7 shows the number of wetted cells, n, and the wetted area, A, versus volume, V, for water on a series of structured hemi-wicking surfaces, treated graphite with pillar asperities, where channel width, w (=y−x), was held constant at 400 μm and pillar width to cell spacing ratios, x/y, were varied from 0.38 to 0.65, see data Table 2, samples 7-10. For all four surfaces, z≈420 μm and θₐ≈40°. Both n and A increased linearly with V. As the relative size of the channel decreased (i.e., x/y became smaller), n and A increased. Narrow channels cause the liquid to wick farther, covering a greater area. The solid lines, calculated from eqs (20) and (21), accurately fit the experimental data. The samples were all fully compliant, contact force ratio 1.4 or greater and asperity rise angle of about 90 degrees.

### Example 5

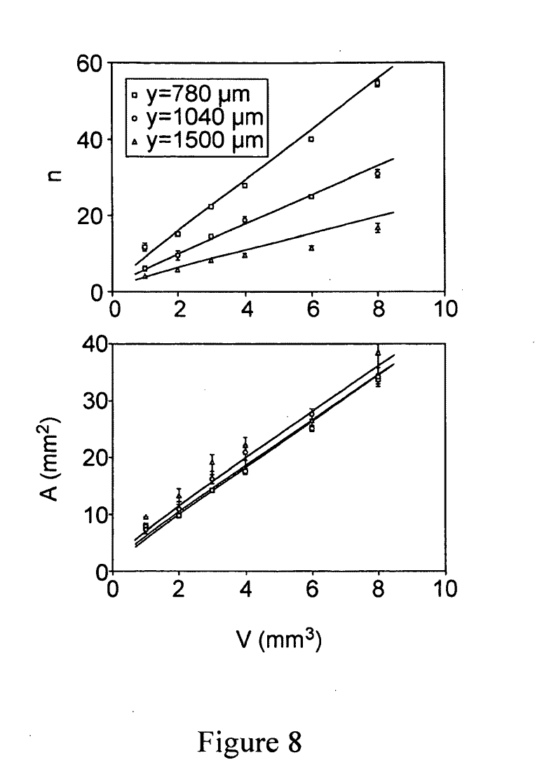

In FIG. 8, the number of wetted cells, n, and the wetted area, A, are plotted against volume, V, for water on another series of structured hemi-wicking surfaces (treated graphite with pillar asperities). In contrast to the previous plot, pillar width to cell spacing ratios were held constant at about x/y=0.5 and unit cell widths, y, were varied, see Table 2 samples 11-13. These surfaces had the same channel depth and lyophilicity as those in FIG. 7, z≈420 μm and θₐ≈40°. Points are experimental data. Here, n decreased as the size of the unit cells increased. However, A was invariant. These results show that if x/y, z and θₐ are held constant, then the absolute size of the unit cell is relatively unimportant. Predicted values shown as solid lines fit the data well. For a rise angle of about 90 degrees the samples were all fully compliant where contact force ratio was 1.4 or greater and partially compliant for contact ratio of 1.4 or greater.

### Example 6

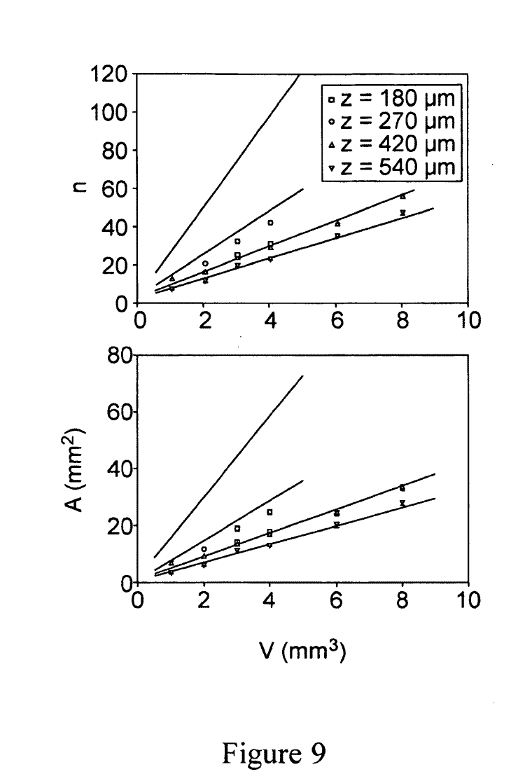

FIG. 9 shows the number of wetted cells, n, and the wetted area, A, versus volume, V, for water on a series of structured hemi-wicking surfaces, treated graphite with pillar asperities, with various pillar heights or channel depths, ranging from z=180 μm to 540 μm, see Table 2 samples 14-17. The surface features were square pillars (ω=90°) with width of x≈380 μm and unit cell width of y≈780 μm. The advancing contact angle on the smooth portions of these surfaces was θₐ≈40°. The points are experimental data and the solid lines were calculated with eqs (20) and (21). The two structured surfaces with the deeper channels, z=420 μm and 540 μm, yielded fully-compliant hemi-wicking. Here, predicted values of n and A agreed well with the experimental data.

In the case of the two surfaces with shallower channels, z=180 μm and 270 μm, even though water spread to produce a square shaped patch, wetting was only partially-compliant. Consequently, predicted values were too large. Without wishing to be bound by theory, as the channels between square pillars became shallower a reduction in the length of contact line in each unit cell, which equates to more poorly defined surface capillaries, may have reduced the magnitude of the wetting force available to stretch the air-liquid interface. Viewed from the side, the water spread flat over the tops of the short pillars, but did not form menisci between them. Therefore, ignoring the term for meniscus curvature in eq (14) improved agreement between observed and computed values of n and A.

### Example 7

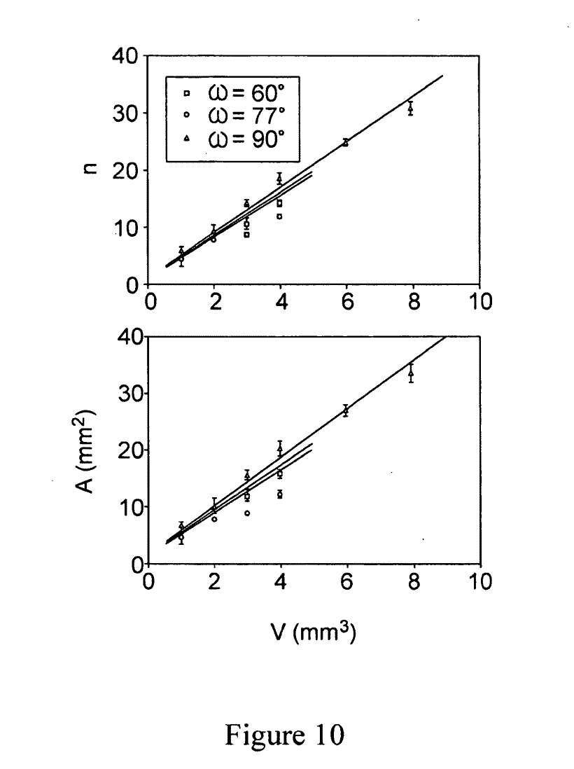

FIG. 10 shows the number of wetted cells, n, and the wetted area, A, versus volume, V, for water on structured hemi-wicking surfaces, treated graphite with frustra asperities, covered with regular arrays of frustra (ω=60° and 77°), see samples 18-20 Table 2. Data for square pillars (ω=90°) was included for comparison. For all three surfaces, x≈500 μm, y≈1000 μm, z≈400 μm and θₐ≈40°. Points are experimental data; solid lines are calculated from eqs (11), (12), (20) and (21). The surface covered with square pillars exhibited fully compliant wetting. On the other hand, the two surfaces with frustra were only partially compliant. The frustra differed from the pillars in their ability to generate menisci. Lower ω values should have meant less meniscus curvature. With θₐ≈40°, the menisci should have been shallow for ω=77° and nearly non-existent for ω=60°. For ω=77°, the frustra pierced the air-liquid interface, but did not exhibit menisci. For ω=60°, the frustra did not protrude through the water—their tops were covered with a thin water film. Without wishing to be bound by theory, while the features had the same base dimensions, the frustra occupied less volume in each unit cell than the pillars. The smaller ω values of the frustra also reduced the length of contact line in each unit cell available to stretch the air-liquid interface.

In the samples illustrated in Table 2, those having an fₗᵢₙₑ/f_{liquid} ratio greater than 1.3 were fully compliant.

A simple ratio of competing forces at the contact line and within the liquid, fₗᵢₙₑ/f_{liquid}, was can be used to gauge their relative contribution to topography driven spreading,

fₗᵢₙₑ/f_{liquid}=cos θₐ[1+2(z/y)(cscω−cot ω)]. (25)

When fₗᵢₙₑ/f_{liquid} is sufficiently large, interactions at the contact line can overpower the minimizing forces of the air-liquid interface and the hemi-wicking can be fully compliant. Table 2 shows values for the various liquid-surface combinations examined in the Examples. The combinations are grouped to show the influence of the key parameters: θₐ, γ, x/y, w=y−x, y and ω. It was observed that for the various surfaces that fₗᵢₙₑ/f_{liquid} ratio≧1.4 resulted in wetting that was fully compliant for rise angles of about 90 degrees.

The competition between forces at the contact line and those within the air-liquid interface determines the extent of wetting, and may be used to change a partially compliant surface to a fully compliant wetting by increasing the amount of contact line per unit cell or by increasing the wettability. For example, a partially compliant structured surface for water with swallow channels (x=370 μm, y=780 μm, z=270 μm and ω=90°, sample 15) was further treated to reduce θₐ from 40° to approximately 10°. Here, water drops were deposited and the extent of spreading was compared to the surfaces with larger θₐ values. A lower contact angle improved coverage, but did not yield full compliance. It seems that the surface structure may be more important than wettability (i.e., θₐ or γ) for determining spreading on these surfaces.

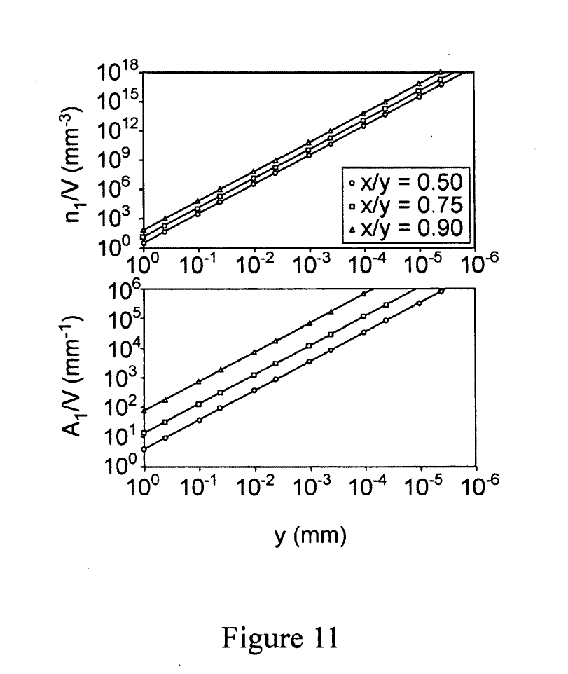

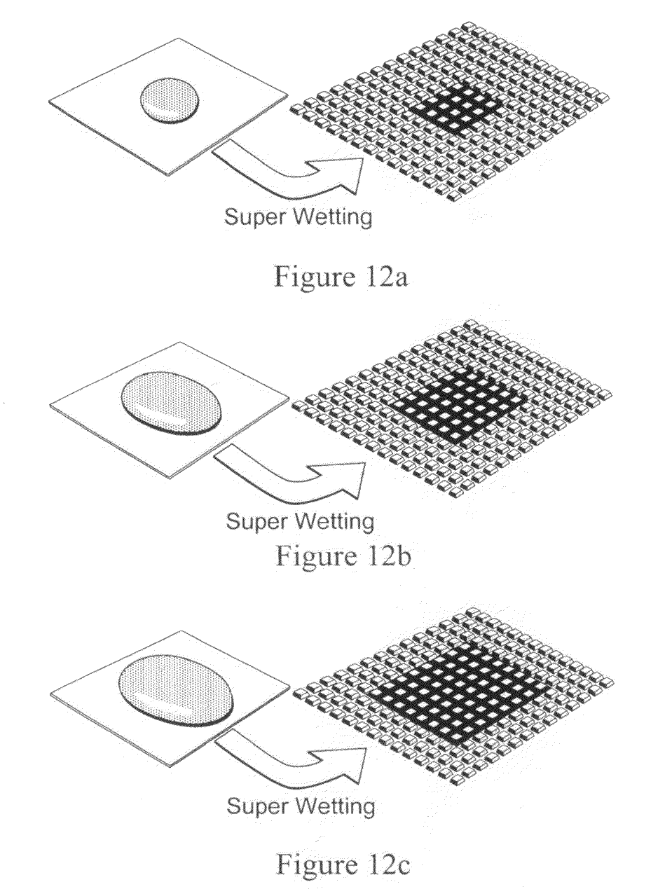

In some embodiments of surface structured hemi-wicking surfaces, the channels can be made deep enough and lyophilic enough that fully compliant wetting is achieved. In some embodiments the channels can be made narrow to cause the wicking liquid to cover a larger area. For durability and ease of manufacture the surfaces features can be made so that the channels are not too narrow or too deep. However, if too shallow, n and A will be reduced. In some embodiments the surfaces may comprise narrow, lyophilic channels (x/y≧0.5 and θₐ<50°) where their width and depth are approximately equal (w=z). For example, FIG. 11 shows calculated n_{f}/V and A_{f}/V values for water that has spread on a homologous series of hemi-wicking surfaces consisting of regular arrays of square pillars having a wide range of y values, where θₐ=40°, z=y−x and x/y=0.50, 0.75 or 0.90. Decreasing the value of y is equivalent to shrinking the unit cell dimensions, while the aspect ratio of the channel cross-section and its size relative to the unit cell spacing are both held constant. Therefore, for a given volume of liquid as dimensions become smaller, the area coverage increases. Accordingly, where the volume of liquid deposited on these hemi-wicking surfaces is 1 mm³ and x/y=0.50, then for y=100 μm, A_{f}=32 mm². However for y of about 1 μm, then A_{f} increases by orders of magnitude to about 3200 mm². In contrast, a liquid drop of the same volume on a smooth lyophilic surface (θₐ=10°) would cover only 12 mm². Advantageously materials in embodiments of the present invention that have structured surfaces comprising asperities with interconnected channels can provide fully compliant wetting or partially compliant wetting when flat surfaces of such materials without structure or asperities have an advancing contact angle greater than zero; in some embodiments an advancing contact angle of 10 degrees, or more; in some embodiments an advancing contact angle of 25 degrees, or more; and in still other embodiments an advancing contact angle of 40 degrees, or more. In contrast prior rough surfaces are only able to achieve complete wetting (apparent or effective contact angle is zero) on a rough surface when the Young contact angle is zero or when the contact angle is zero. Embodiments of structured surfaces in the present invention provides greater stability and durability for the wetting characteristics of the surface since highly lyophilic surfaces can attract contaminants and zero or near zero contact angles may be difficult to maintain.

Structured surfaces in embodiments of the invention may be inclined, for example in a fuel cell distribution plate or as portions of a filter core, cage, or housing bowl. These structured surfaces may be made on one or more surfaces of the channels or faces of these, for example the distribution plate channels. The orientation may have no significant influence on the extent or spreading, direction of the spreading, or the shape of the wetted area. The same approach could be applied to other channel geometries, ordered or random.

Embodiments of the invention improve the apparent lyophilicity of a surface by introducing structure or texture. Surface features that create a network of capillary channels that enhance liquid spreading. In some embodiments the orthogonal geometry of these particular surfaces led to square-shaped wetting areas. Hemi-wicking varied with the geometry of the surfaces and to a lesser extent with surface tension of the liquid or the strength of the molecular interactions at the contact line (as gauged by contact angle).

Two different types of hemi-wicking behavior can be provided by surface structures in embodiments of the invention fully compliant or partially compliant. Fully compliant wetting of hemi-wicking surfaces occurred where the strength of the interactions at the contact line overpowered the restoring forces associated with the air-liquid interfacial tension; liquid was completely drawn into the interstitial spaces and established menisci that exhibited an advancing contact angle on the side of the lyophilic asperities. In partially compliant hemi-wicking, competing forces are comparable in magnitude and in these embodiments the liquid did not exhibit menisci or a thin liquid layer masked the features.

In embodiments of the surfaces where the liquid penetrated the surface structure and full compliance was achieved, then the inherent wettability was relatively unimportant. In these embodiments if the channels were made shallower or narrower, liquid spread over a larger area.

Table 1. The number of wetted unit cells, n, and wetted areas, A, on a structured fully compliant hemi-wicking treated graphite surface with asperities after deposition of water drops of various volumes, V. The surface consisted of a regular array of square pillars (ω=90°) with width of x=380 μm and height of z=420 μm, and unit cell width of y=780 μm. The corresponding smooth surface had an advancing contact angle of θₐ=40°.

| Experimental values | | | Calculated values | | | |
|---|---|---|---|---|---|---|
| V | | A | | A_{f} | | Aₑ |
| (mm³) | n | (mm²) | n_{f} | (mm²) | nₑ | (mm²) |
| 1.0 | 12.0 ± 1.0 | 7.3 ± 0.7 | 6.1 | 3.7 | 9.1 | 5.5 |
| 2.0 | 15.3 ± 0.6 | 9.3 ± 0.4 | 12.2 | 7.4 | 16.2 | 9.9 |
| 3.0 | 22.7 ± 0.6 | 13.8 ± 0.5 | 18.3 | 11.1 | 23.1 | 14.0 |
| 4.0 | 28.3 ± 0.6 | 17.2 ± 0.5 | 24.4 | 14.8 | 29.9 | 18.1 |
| 6.0 | 40.7 ± 0.6 | 24.7 ± 0.6 | 36.6 | 22.2 | 43.2 | 26.2 |
| 8.0 | 55.0 ± 1.0 | 33.4 ± 0.9 | 48.8 | 29.7 | 56.3 | 34.2 |
| 96 | 600 ± 10 | 360 ± 10 | 590 | 360 | 610 | 370 |

Values of n_{f} and A_{f} were calculated with eqs (13) and (14); nₑ and Aₑ were computed from eqs (20) and (21).

TABLE 2
Ratios of the forces acting at the contact line and within the fluid-liquid
interface, fₗᵢₙₑ/f_{liquid}, for various liquid-solid combinations.

| | γ | θₐ | x | y | z | ω | y − x | | | |
|---|---|---|---|---|---|---|---|---|---|---|
| Liquid(sample) | (mN/m) | (°) | (μm) | (μm) | (μm) | (°) | (μm) | x/y | Compliance | fₗᵢₙₑ/f_{liquid} |
| Water (1) | 72 | 10.7 | 390 | 770 | 420 | 90 | 380 | 0.51 | Full | 2.0 |
| Water (2) | 72 | 27.1 | 390 | 770 | 420 | 90 | 380 | 0.51 | Full | 1.9 |
| Water (3) | 72 | 40.4 | 380 | 780 | 420 | 90 | 400 | 0.49 | Full | 1.6 |
| EG (4) | 48 | 16.9 | 380 | 780 | 420 | 90 | 400 | 0.49 | Full | 2.0 |
| FA (5) | 58 | 26.3 | 380 | 780 | 420 | 90 | 400 | 0.49 | Full | 1.9 |
| Water (6) | 72 | 40.4 | 380 | 780 | 420 | 90 | 400 | 0.49 | Full | 1.6 |
| Water (7) | 72 | 38.1 | 250 | 650 | 440 | 90 | 400 | 0.38 | Full | 1.9 |
| Water (8) | 72 | 40.4 | 380 | 780 | 420 | 90 | 400 | 0.49 | Full | 1.6 |
| Water (9) | 72 | 39.8 | 520 | 910 | 420 | 90 | 390 | 0.57 | Full | 1.5 |
| Water (10) | 72 | 35.3 | 760 | 1170 | 440 | 90 | 410 | 0.65 | Full | 1.4 |
| Water (11) | 72 | 40.4 | 380 | 780 | 420 | 90 | 400 | 0.49 | Full | 1.6 |
| Water (12) | 72 | 42.3 | 520 | 1040 | 440 | 90 | 520 | 0.50 | Full | 1.4 |
| Water (13) | 72 | 42.8 | 730 | 1500 | 420 | 90 | 770 | 0.49 | Partial | 1.1 |
| Water (14) | 72 | 39.0 | 350 | 770 | 180 | 90 | 420 | 0.45 | Partial | 1.1 |
| Water (15) | 72 | 41.0 | 370 | 780 | 270 | 90 | 410 | 0.48 | Partial | 1.3 |
| Water (16) | 72 | 40.4 | 380 | 780 | 420 | 90 | 400 | 0.49 | Full | 1.6 |
| Water (17) | 72 | 41.8 | 400 | 780 | 540 | 90 | 380 | 0.51 | Full | 1.8 |
| Water (18) | 72 | 39.9 | 520 | 1040 | 410 | 60 | 520 | 0.50 | Partial | 1.1 |
| Water (19) | 72 | 39.9 | 490 | 1000 | 470 | 77 | 510 | 0.49 | Partial | 1.3 |
| Water (20) | 72 | 42.3 | 520 | 1040 | 440 | 90 | 520 | 0.50 | Full | 1.4 |

Although the present invention has been described in considerable detail with reference to certain preferred embodiments thereof, other versions are possible. Therefore the spirit and scope of the appended claims should not be limited to the description and the preferred versions contain within this specification.

What is claimed is:

1. An article comprising:
a substrate having one or more treated surfaces with asperities, said asperities form intersecting capillary channels between the asperities, said treated surface with asperities has an advancing contact angle as measured by a sessile drop of water that is at least 30 degrees less than an untreated surface of said substrate without asperities;
said treated surface with asperities characterized in that an area wet by a liquid spreading on said treated surface with asperities is proportional to the volume of a drop of the liquid disposed on said treated surface with asperities and where the strength of interaction of the liquid at the contact line with the treated surface with asperities is greater than the restoring forces associated with the air-liquid interfacial tension, and whereby the liquid on the treated surface with asperities is completely drawn into the intersecting capillary channels and the liquid establishes an advancing contact angle on the side of the asperities and forms menisci between said asperities.

2. The article of claim 1 wherein said asperities have a rise angle of about 90 degrees from the base of the capillary channels formed between said asperities, said asperities have one or more unit cells having y less than 1500 microns and maximum surface feature dimension x less than 1000 microns and height z of less than 1000 microns.

3. The article of claims 1 or 2 wherein said treated surface with asperities has an advancing contact angle as measured by a sessile drop of water that is at least 40 degrees less than an untreated surface of said substrate without asperities.

4. An article comprising:
a substrate having one or more treated surfaces with asperities, said asperities form intersecting capillary channels between the asperities, said treated surface with asperities has an advancing contact angle as measured by a sessile drop of water that is at least 30 degrees less than an untreated surface of said substrate without asperities;
said treated surface with asperities characterized in that an area wet by a liquid spreading on said treated surface with asperities is proportional to the volume of a drop of the liquid disposed on said treated surface with asperities and whereby the liquid on the structured surface drawn into the capillary channels does not establish an advancing contact angle on the side of the asperities and where the liquid does not forms menisci between said asperities.

5. The article of claim 4 wherein said asperities have a rise angle of less than 90 degrees and said capillary channels formed between said asperities have one or more unit cells having y less than 1200 microns and maximum surface feature dimension x less than 800 microns and height z of less than 500 microns.

6. The article of claims 4 or 5 wherein said treated surface with asperities has an advancing contact angle as measured by a sessile drop of water that is at least 40 degrees less than an untreated surface of said substrate without asperities.

7. An article comprising:
a substrate having one or more treated surfaces with asperities, said asperities form intersecting capillary channels between the asperities, said treated surface with asperities has an advancing contact angle as measured by a sessile drop of water that is at least 30 degrees less than an untreated surface of said substrate without asperities;
said treated surface with asperities characterized in that an area wet by a liquid spreading on said treated surface with asperities is proportional to the volume of a drop of the liquid disposed on said treated surface with asperities and where the contact line liquid force ratio fₗᵢₙₑ/f_{liquid} is equal to or greater than 1.4 where fₗᵢₙₑ is the force at the contact line and f_{liquid} is the interfacial force that resists spreading of the liquid according to the equation:
fₗᵢₙₑ/f_{liquid}=cos θₐ[1+2(z/y)(cscω−cot ω)]
where z is channel height, y is the unit cell, ω is the average rise angle and is about 90 degrees, and θₐ is the advancing contact angle of water; and
wherein said treated surface with asperities is a fully compliant wetting hemi-wicking surface for water.

8. The article of claim 7 wherein said capillary channels formed between said asperities have one or more unit cells having y less than 1200 microns and maximum surface feature dimension x less than 800 microns and height z of less than 500 microns.

9. The article of claim 7 where the asperities form a square array.
